(19) United States
(12) Patent Application Publication
(10) Pub. No.: US 2025/0202871 A1
(43) Pub. Date: Jun. 19, 2025

(54) VEHICLE NETWORK SECURITY SYSTEM USING SYMMETRIC KEYS DERIVED BASED ON TIME SYNCHRONIZATION

(71) Applicant: HYUNDAI AUTOEVER CORP., Seoul (KR)

(72) Inventors: Sung Jin Choi, Seoul (KR); Dong Jae Won, Seoul (KR); Sang Won Kim, Seoul (KR)

(73) Assignee: HYUNDAI AUTOEVER CORP., Seoul (KR)

(21) Appl. No.: 18/948,144

(22) Filed: Nov. 14, 2024

(30) Foreign Application Priority Data
Dec. 13, 2023 (KR) 10-2023-0180265

(51) Int. Cl. H04L 9/40; H04L 9/08

(52) U.S. Cl. CPC H04L 63/0435; H04L 9/085; H04L 9/0861; H04L 9/0894

(57) ABSTRACT

A vehicle network security system using symmetric keys derived based on time synchronization includes a symmetric key generation unit configured to generate a symmetric key shared by a transmission unit that transmits data and a reception unit that receives data, and store the symmetric key in a specific slot. The vehicle network security system also includes a symmetric key processing unit configured to call the symmetric key in the specific slot to transmit and receive data when an application software program creates an encryption or decryption session. The symmetric key is generated using a factor synchronized with time data transferred from a hardware clock (HC) included in electronic control units (ECUs) in a vehicle network.

### CROSS REFERENCE TO RELATED APPLICATION

This application claims the benefit of and priority to Korea Patent Application No. 10-2023-0180265, filed on Dec. 13, 2023, the entire contents of which are hereby incorporated herein by reference.

### FIELD OF TECHNOLOGY

The present disclosure relates to a vehicle network security system using symmetric keys derived based on a time synchronization process included in a vehicle network.

### BACKGROUND

The statements in this section merely provide background information related to the present disclosure and may not constitute prior art.

In a vehicle network security system, it is essential to share symmetric keys between a transmission stage and a reception stage for safe data transmission and reception. However, there is a difficulty in that the exchange of such symmetric keys should be done through a security-vulnerable non-safe channel that is not a safe channel.

One main method for safely exchanging symmetric keys is a key exchange mechanism using asymmetric keys. This mechanism is effective in exchanging safe symmetric keys, but has the disadvantage of a long computation time.

A computational load problem of the key exchange mechanism using asymmetric keys is a serious problem in real-time communication. In particular, when a large amount of data is transferred safely, the efficiency is greatly degraded due to such a computational load. Therefore, a problem arises in that a high response speed of communication and the efficiency of large-capacity data transfer become difficult.

Further, when it is desired that the transmission and reception stages derive the same symmetric key without using an asymmetric key, additional procedures and information are required. Here, the transmission and reception stages should share a unique salt value in use for each session, which should be safely exchanged and effectively managed. When the salt value is leaked or modified, this may have a fatal influence on an entire security system.

### SUMMARY

The present disclosure has been made in view of the above problems. An object of the present disclosure is to provide a vehicle network security system that can quickly and efficiently derive symmetric keys using a time value that is synchronized in real time.

Further, another object of the present disclosure is to provide a vehicle network security system that generates a large number of symmetric keys in advance and manages the symmetric keys.

Further, yet another object of the present disclosure is to provide a vehicle network security system that can reduce an unnecessary load during actual operation of an application software program by using a large number of symmetric keys generated in advance.

According to an embodiment, a vehicle network security system using symmetric keys derived based on time synchronization is provided. The vehicle network security includes a symmetric key generation unit configured to generate a symmetric key shared by a transmission unit configured to transmit data and a reception unit configured to receive data, and store the symmetric key in a specific slot. The vehicle network security also includes a symmetric key processing unit configured to call the symmetric key in the specific slot to transmit and receive data when an application software program creates an encryption or decryption session, wherein the symmetric key is generated by using a factor synchronized with time data transferred from a hardware clock (HC) included in electronic control units (ECUs) in a vehicle network.

The symmetric key may be generated through a key derivation function (KDF).

The KDF may be operated on parameters including an input secret key, a salt parameter, a difficulty level parameter, and a key size.

The salt parameter may be obtained through the factor synchronized with the time data.

The ECU may include an application layer including an application software program, a hardware layer including a hardware configuration, and an adaptive platform layer for an interaction between the application layer and the hardware layer.

The hardware clock may be included in the hardware layer, and the hardware clock may include a hardware clock for an Ethernet-based precision time protocol (PTP).

The factor synchronized with the time data may be acquired using a pulse per second (PPS) signal.

The PPS signal may be acquired by connecting a software defined pin (SDP) output of an Ethernet controller included in the hardware layer to an SDP Input of the Ethernet controller and then performing a setting so that a pulse is periodically emitted from the SDP output.

A signal handler used to process a rising edge of the pulse may be registered in the application software program, and the time data may be acquired within the registered signal handler.

A hardware clock of the transmission unit and a hardware clock of the reception unit may have a time error value of 100 nanoseconds (ns) or less by using the factor synchronized with the time data.

The symmetric key may be generated by using time data in microseconds (μs) or more.

According to an embodiment, a vehicle network security communication method using symmetric keys derived based on time synchronization is provided. The vehicle network security communication method includes a symmetric key generation step of generating a symmetric key shared by a transmission unit configured to transmit data and a reception unit configured to receive data, and storing the symmetric key in a specific slot. The vehicle network security communication method also includes a symmetric key processing step of calling the symmetric key in the specific slot to transmit and receive data when an application software program creates an encryption or decryption session, wherein the symmetric key is generated by using a factor synchronized with time data transferred from a hardware clock (HC) included in a hardware layer of electronic control units (ECUs) in a vehicle network.

The symmetric key generation step may include a time value factor generation step for generating the factor synchronized with the time data through a PPS signal received by an application software program included in an application layer of the ECU; a parameter generation step for obtaining a parameter by using the factor; a symmetric key acquisition step for acquiring the symmetric key through a function operated by the parameter; and a symmetric key storage step for storing the acquired symmetric key in the specific slot.

The symmetric key may be generated through a key derivation function (KDF).

The KDF may be operated on parameters including an input secret key, a salt parameter, a difficulty level parameter, and a key size.

The salt parameter may be obtained through the factor synchronized with the time data.

The PPS signal used in the time value factor generation step performed in the symmetric key generation step may be acquired by connecting a software defined pin (SDP) output of an Ethernet controller included in the hardware layer to an SDP Input of the Ethernet controller and then performing a setting so that a pulse is periodically emitted from the SDP output.

Prior to the symmetric key processing step, the symmetric key generation step may be repeatedly performed at each rising edge of the pulse to generate and store a plurality of symmetric keys in advance.

According to yet an embodiment, a vehicle network security device using symmetric keys derived based on time synchronization is provided. The vehicle network security device includes a symmetric key generation unit configured to generate a symmetric key shared by a transmission unit configured to transmit data and a reception unit configured to receive data, and store the symmetric key in a specific slot. The vehicle network security device also includes a symmetric key processing unit configured to call the symmetric key in the specific slot to transmit and receive data when an application software program creates an encryption or decryption session. The symmetric key is generated by using a factor synchronized with time data transferred from a hardware clock (HC) included in electronic control units (ECUs) in a vehicle network. A hardware clock of the transmission unit and a hardware clock of the reception unit have a time error value of 100 ns or less by using the factor synchronized with the time data.

The symmetric key may use time data in us or more.

As described above, according to embodiments of the present disclosure, with a hardware clock configuration included in electronic control units (ECUs) of a vehicle network, it is possible to provide a vehicle network security system that can quickly and efficiently derive a symmetric key by using a time value that is synchronized in real time.

Further, according to embodiments of the present disclosure, it is possible to provide a vehicle network security system that generates a large number of symmetric keys in advance and manages the symmetric keys.

Furthermore, according to embodiments of the present disclosure, it is possible to provide a vehicle network security system that can reduce an unnecessary load when an application software program actually operates, by using a large number of symmetric keys generated in advance.

The technical problems to be solved in this document are not limited to the technical problems mentioned above. Other technical problems that are not mentioned herein should be more clearly understood by those having ordinary skill in the art to which the present disclosure pertains from the following description.

### BRIEF DESCRIPTION OF THE DRAWINGS

FIG. 1 is a block diagram illustrating a vehicle network security system according to an embodiment.

FIG. 2 is a diagram illustrating a KDF for generating a symmetric key according to an embodiment.

FIG. 3 is a schematic diagram illustrating an ECU according to an embodiment.

FIG. 4 is a diagram illustrating an example in which a plurality of ECUs in a vehicle network use the same time band through time synchronization according to an embodiment.

FIG. 5 is a diagram illustrating an example in which a PPS signal is acquired according to an embodiment.

FIG. 6 is a flowchart showing a vehicle network security communication method according to an embodiment.

FIG. 7 is a flowchart showing symmetric key generation according to an embodiment.

### DETAILED DESCRIPTION

Hereinafter, some embodiments of the present disclosure are described in detail with reference to the accompanying drawings. When components in respective drawings are denoted by reference signs, it should be noted that the same components are denoted by the same signs as much as possible even when the components are shown on different drawings. Further, when the present disclosure is described, when it was judged that a detailed description of related known configurations or functions may obscure the gist of the present disclosure, the detailed description thereof has been omitted.

Further, when components of the present disclosure are described, terms such as first, second, A, B, (a), and (b) may be used. These terms are only intended to distinguish the components from other components. The nature, order, or sequence of the components is not limited by the terms. When a component is described as being “connected” or “coupled” to another component, it should be understood that the component may be directly connected or coupled to the other component, or one or more other components may also be “connected” or “coupled” between the respective components.

When a component, device, module, element, or the like of the present disclosure is described as having a purpose or performing an operation, function, or the like, the component, device, or element should be considered herein as being “configured to” meet that purpose or perform that operation or function.

The terms “ . . . unit,” “module,” “device,” “controller,” and the like in the specification refer to a unit that processes at least one function or operation, and may be implemented in hardware, software or a combination of hardware and software. The operations of the functions described in connection with the forms disclosed herein may be embodied directly in a hardware or a software module comprising computer-readable instructions stored in a non-transitory storage medium or media and executed by a processor, or in a combination thereof.

Embodiments of the present disclosure provide a vehicle network security system using symmetric keys derived based on time synchronization. The vehicle network security system includes a symmetric key generation unit configured to generate a symmetric key shared by a transmission unit configured to transmit data and a reception unit configured to receive data, and store the symmetric key in a specific slot. The vehicle network security system also includes a symmetric key processing unit configured to transfer the symmetric key in the specific slot that is called when an application software program creates an encryption or decryption session. The symmetric key is generated by using a factor synchronized with time data transferred from a hardware clock (HC) included in electronic control units (ECUs) in a vehicle network.

The symmetric key plays an important role in an encryption and decryption algorithm. The symmetric key acts as a key element in maintaining the confidentiality of data and providing safe communication. Use of such a symmetric key and algorithms based on the symmetric key may be used for safe communication in various fields.

The symmetric key is a type of algorithm that uses the same key for encryption and decryption, and has a simple and effective structure. When the same symmetric key is shared between two communication modules, data can be safely encrypted and decrypted using the symmetric key.

One of the most important uses of the symmetric key is to guarantee the confidentiality of data. Encrypted data may be safely transferred and stored by sharing the same symmetric key between two communicating modules. This may be used in various communication schemes such as e-mail, file transfer, and web communication, for example.

Further, the symmetric key may provide high calculation speed and efficiency. Since encryption and decryption are performed using the same symmetric key, calculation is fast and a large amount of data can be processed efficiently. Accordingly, the symmetric key may be effectively used in a large-scale data processing environment.

The symmetric key provides an effective key exchange mechanism, and is one important characteristic for overcoming the difficulty in key exchange. Since the same key only needs to be shared between two communicating modules, effective key exchange may be realized. Therefore, according to an embodiment of the present disclosure, a time synchronization technology is used to share the same key between the communicating modules.

Various symmetric key algorithms are used to guarantee the confidentiality of data. Examples of representative symmetric key algorithms include a data encryption standard (DES) and an advanced encryption standard (AES), and may be selected and used in various situations according to respective characteristics of the algorithms.

Further, the symmetric key is used in various forms such as stream encryption and block encryption algorithms. The block encryption algorithm is used to encrypt data having a fixed block size, and DES and AES are representative examples. On the other hand, the stream encryption algorithm is used to encrypt data in units of bits, and an RC4 algorithm is a representative example.

The symmetric key may also be used in a hash function and a hash-based message authentication code (HMAC). The HMAC is a mechanism for guaranteeing integrity of data. The HMAC provides safe authentication by combining the hash function with the symmetric key.

In data transfer, symmetric keys may be used to safely encrypt and transfer data between both parties. This is used in various communication schemes such as e-mail, file transfer, and web communication, and can realize safe data transfer.

The symmetric key may be used for safe storage of data. Disk encryption and file encryption are based on the symmetric key for the safe storage of data.

In a cloud service, data may be safely protected by using the symmetric key. The data can be stored and exchanged on the cloud with confidentiality of the data maintained.

The symmetric key may also be used in a secure sockets layer (SSL) and a transport layer security (TLS) protocol. Safe communication between a web browser and a web server is provided, and the confidentiality of communication may be guaranteed through session key exchange.

The vehicle network security system according to an embodiment of the present disclosure may use a counter mode encryption/decryption algorithm.

Counter mode encryption/decryption is one block cipher operation mode and is an effective method for providing data confidentiality. A key stream is generated by using a counter that constantly increases each time each block is encrypted, thereby providing high-performance encryption capability and the advantages of parallelization while minimizing inter-block dependency.

First, a counter should be generated in order to start the algorithm. The generated counter constantly increases when block encryption is performed, and provides an important configuration in generating a key stream for each block. A specific operation may be performed to encrypt a plaintext block, thereby creating a ciphertext block and encrypting data while minimizing dependency on existing blocks.

A counter mode can be considered a type of stream cipher similar to an output feedback (OFB) mode encryption/decryption algorithm. However, the counter mode is characterized by directly generating a key stream using a counter value, unlike the OFB mode. Further, with similar structures for encryption and decryption, implementation is simplified, and consistency is maintained, thereby providing the stability.

Further, in the counter mode, processing order of blocks may be arbitrarily changed. Further, the fact that the order of blocks can be predicted through the counter value can be advantageous in parallel processing. In addition, even when the same counter value is used, security can be maintained by using a counter value unique to each block.

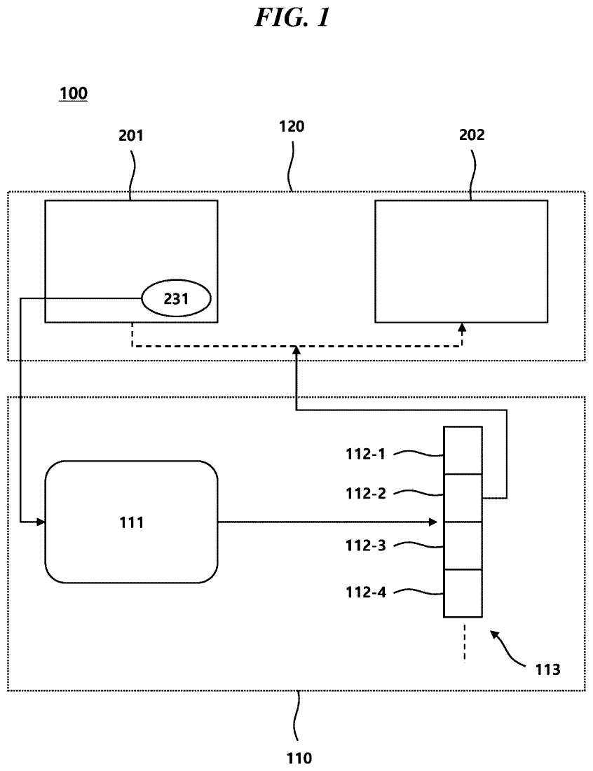

FIG. 1 is a block diagram illustrating a vehicle network security system according to an embodiment.

Referring to FIG. 1, a vehicle network security system 100 according to an embodiment may include a symmetric key generation unit 110 and a symmetric key processing unit 120.

The symmetric key generation unit 110 may generate a symmetric key 112 that is shared by a transmission unit 201 and a reception unit 202 that transmit and receive data. The symmetric key generation unit 110 may store the symmetric key 112 in a specific slot 113.

The specific slot 113 is a space where the symmetric key 112 can be stored, and may store a plurality of symmetric keys 112-1, 112-2, 112-3, and 112-4 generated in advance. Among the plurality of stored symmetric keys 112-1, 112-2, 112-3, and 112-4, the symmetric key 112-2 in the specific slot may be used in the symmetric key processing unit 120. Although only the four symmetric keys 112-1, 112-2, 112-3, and 112-4 are shown in FIG. 1, the present disclosure is not limited thereto. In various embodiments, four or more symmetric keys 112 may be stored in the slot 113 and used as needed.

In the symmetric key processing unit 120, when the application software program creates an encryption or decryption session, the symmetric key 112 of the specific slot 113 may be called and data may be transmitted or received by using the called symmetric key 112.

In the symmetric key 112, a factor may be transferred from a hardware clock (HC) 231 included in electronic control units (ECUs) within a vehicle network and used. Here, the factor transferred to the symmetric key 112 may be synchronized with time data. Thus, since the symmetric key 112 is generated in synchronization with time data information within the vehicle network, the uniqueness and security of data to be transmitted and received can be guaranteed.

The symmetric key 112 may be generated through a key derivation function (KDF).

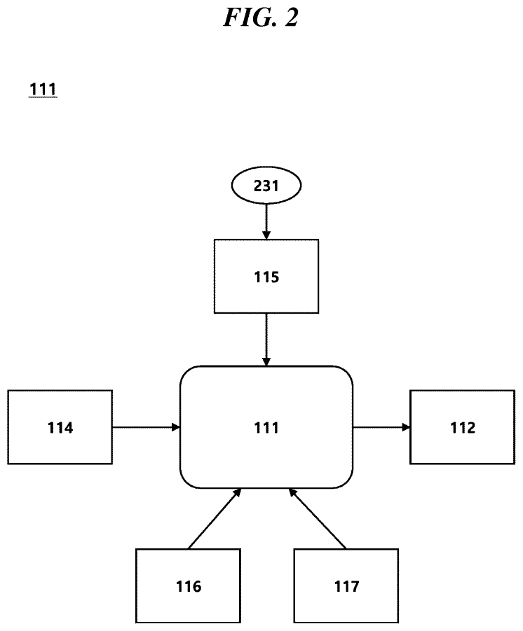

FIG. 2 is a diagram illustrating a KDF for generating a symmetric key.

Referring to FIG. 2, the symmetric key 112 may be generated by a KDF 111 that operates on parameters including an input secret key 114, a salt parameter 115, a difficulty level parameter 116, and a key size 117.

The salt 115 parameter may be obtained through the factor synchronized with the time data transferred from the hardware clock 231.

The key derivation function (KDF) 111 is an important tool for generating a safe key in a symmetric key encryption system. The KDF 111 is mainly used to generate a key in use for a symmetric algorithm, and safety and unpredictability of the KDF 111 may determine the strength of the entire security system.

Main input elements of the KDF 111 include the input secret key 114, the salt 115, the difficulty level 116, and the key size 117.

The input secret key 114 is used as a basic input of the KDF 111. The input secret key 114 may include a safe random value or a random number. The safety of the input secret key 114 has a direct influence on the safety of the entire system, and a higher entropy value that is difficult to predict may be advantageous for the safety.

The salt parameter 115 is another important input parameter in use for the KDF 111. Addition of the salt 115 to the input secret key 114 may further increase the security. Even when the same input secret key 114 is used, a different key is generated if a different salt 115 is used, and therefore, the security may be increased.

In general, the salt 115 is generated randomly and should be unique to a derivation task for each key. This allows different results to be obtained even when the KDF 111 is performed on the same input secret key 114 several times.

In the vehicle network security system 100 using symmetric keys derived based on time synchronization according to an example of the present disclosure, the salt parameter 115 is obtained through the factor synchronized with the time data, thereby maintaining consistency of data while securing the safety and security of the entire system.

The difficulty level 116 may be called a task factor and may be mainly used for password-based key derivation. The difficulty level parameter 116 may determine how many KDF operations should be performed. A high difficulty level requires high-intensity work, making it difficult to attempt unauthorized access.

An increase in the difficulty level generally leads to increases in a time required for the KDF operation and a computational cost, making it difficult to guess a secret key.

The key size 117 may be designated by a user. The key size 117 may be set according to a request of a specific symmetric encryption algorithm, and a safe key size 117 should be guaranteed. In general, since the larger key size 117 improves the security, but increases the required time and the computational cost, the larger key size 117 may be detrimental to performance.

Selecting the appropriate key size 117 may be determined by a security policy of the system and a symmetric algorithm used. The key size 117 may contribute to strengthening the safety of the system.

Data may be safely encrypted or decrypted by using the symmetric key 112 generated through this process. The safety of the KDF 111 may be determined by parameters including the input secret key 114, the salt parameter 115, the difficulty level parameter 116, and the key size 117. Therefore, it is necessary to set an appropriate level of parameters in order to strengthen the security and resistance to unauthorized access. Further, it may be important to implement the KDF 111 using a cryptographically safe hash function.

An encryption algorithm used in embodiments of the present disclosure may include the advanced encryption standard (AES).

The advanced encryption standard (AES) is a main standard for modern symmetric key encryption, and may replace an existing data encryption standard (DES) and 3DES. The advanced encryption standard is used as a core in the fields of IT security and network communication since the advanced encryption standard provides safe and effective block encryption.

The advanced encryption standard may provide security by adopting a block encryption scheme for processing blocks having a fixed size, and the blocks can be subjected to safe conversion from plaintext to ciphertext. Further, since a length of the key can be selected from 128 bits, 192 bits, and 256 bits, supporting various security levels, the key may be applied in various environments.

The advanced encryption standard may use sub-byte conversion and shuffling operations to increase non-linearity of data and perform a substitution and mixing process. This process may be repeated in each round, and data may be processed in multiple stages through a round structure. In each round, the key is expanded so that a subkey is generated, and the subkey can be used in an overall encryption process to improve the security.

In addition, the advanced encryption standard simultaneously provides stability and efficiency based on core principles and mathematical techniques for block encryption. This may meet various modern security requirements and play an important role in guaranteeing data confidentiality.

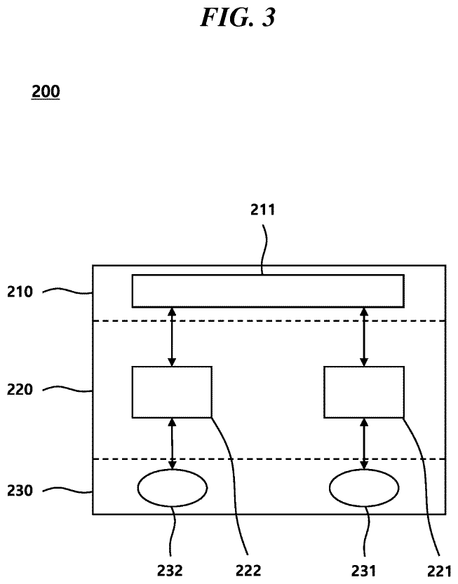

FIG. 3 is a schematic diagram illustrating an ECU according to an embodiment.

Referring to FIG. 3, an ECU 200 according to an embodiment of the present disclosure may include an application layer 210, an adaptive platform layer 220, and a hardware layer 230.

The application layer 210 may include an application software program 211. The hardware layer 230 may include major hardware components necessary for an operation of the ECU 200. The adaptive platform layer 220 may include a platform necessary for interaction between the application layer 210 and the hardware layer 230.

An ECU that is used in a vehicle network system is a major configuration that comprehensively controls and manages various functions of a vehicle.

Such various functions of the vehicle may be implemented through the application software program 211 that is executed on the application layer 210. For example, functions of a driving safety system, vehicle information and related entertainment, a communication system, and/or the like may be included. The application software program 211 included in the application layer 210 may determine related tasks for performing various functions of the vehicle and communicate with the hardware layer 230 to adjust an operation of the vehicle according to the determination.

The hardware layer 230 can be responsible for physical components of the ECU 200. For example, the hardware layer 230 may include sensors, actuators, processors, memories, communication ports, and the like. The hardware layer 230 may perform the tasks determined by the application layer 210 and may collect data from sensors or have an influence on the outside through actuators. The hardware layer 230 may provide a standardized interface and hardware abstraction to secure flexibility and interoperability.

The adaptive platform layer 220 is a configuration for supporting advanced functions for the interaction between the application layer 210 and the hardware layer 230. This adaptive platform layer 220 may provide a dynamic software architecture and can support functions that can be updated at runtime. Further, the adaptive platform layer 220 may perform a function for integrating new technologies that are applied to vehicles, such as automated driving, and can provide flexibility for upgrading and changing a system even when a vehicle is traveling.

For the adaptive platform layer 220 according to an embodiment of the present disclosure, an automotive open system architecture (AUTOSAR) standard may be applied.

The automotive open system architecture (AUTOSAR) standard is an international standard that can be used in the field of automotive industry, and automotive software and electronic systems may be effectively standardized. The AUTOSAR standard can support efficient development, integration, and maintenance of software throughout an entire life cycle of a vehicle, enabling high technological levels and various functions of automobiles.

The AUTOSAR standard provides interoperability with a standard interface between software components that are executed on various vehicle control units (ECUs), enabling efficient management of electronic systems within the vehicle. This makes it possible to standardize communication between the ECUs and secure interoperability, thereby reducing the complexity of the vehicle system.

The AUTOSAR defines and abstracts the standard interface, thereby facilitating communication between the software components and providing a flexible and reusable software architecture while hiding hardware dependencies through the abstraction. This enables efficient management and development of software on various ECUs and hardware platforms.

In addition, the AUTOSAR provides platform independence, thereby facilitating the reuse of software on various hardware platforms. This improves portability of the software and facilitates system upgrades. This also supports dynamic software updates and expansions, thereby enabling rapid response to requirements that change during a life cycle of the vehicle.

The AUTOSAR provides a framework for defining a standardized software architecture, thereby improving the efficiency of software development and maintaining the consistency. This provides a template that defines a structure and interaction of the software components, thereby maintaining a standardized structure and enabling a solution that correspond to various vehicle types and models.

Further, since AUTOSAR has a configurable structure, vehicle manufacturers and system suppliers can adjust software according to their needs. This provides a flexible solution that corresponds to various vehicle types and models, and facilitates the introduction of new technologies.

Further, AUTOSAR provides a standardized communication stack for in-vehicle communication, making it possible to facilitate communication between various ECUs and improve interaction in distributed systems. This enables various functions in a vehicle to be smoothly linked and efficiently operated.

According to an embodiment of the present disclosure, the AUTOSAR standard is applied in the adaptive platform layer 220 to provide the dynamic software architecture for various functions of the vehicle. This may contribute to standardizing and optimizing the software architecture in the ECU 200 of the vehicle network, and there is an advantage of providing flexibility and efficiency to a vehicle manufacturer and a system developer.

The hardware layer 230 may include the hardware clock (HC) 231. The hardware clock 231 may include a hardware clock for Ethernet-based precision time protocol (PTP).

The precision time protocol (PTP) is a core protocol for accurately synchronizing time in a network system, and can satisfy precise timing requirements by synchronizing time with an accuracy of hundreds of nanoseconds (ns) per second. This enables the PTP to provide consistent time between a large number of devices and to implement synchronization between the devices using an accurate timestamp within a network.

The PTP may mainly use a master-slave architecture. Here, one device may be designated as a master to provide accurate time, and other devices may be synchronized to this master device. The PTP measures network delay so that the synchronization between the devices can be adjusted and accurate timing can be maintained.

The PTP may generally operate according to the IEEE 1588 standard. PTPv2, which is a representative IEEE 1588-2008 standard, is used, and communication is performed based on user datagram protocol (UDP). In the network, timing information is exchanged between devices so that accurate synchronization is maintained.

The PTP operates by respective devices periodically exchanging timestamps and measuring network delays to perform the synchronization. In such a process, the PTP measures a network latency and compensates for this so that the devices can actually use the same time.

When the PTP is applied, a network system enables improvement of performance, data accuracy, and cooperation between distributed systems. Further, a PTP hardware clock (PHC), which is an Ethernet-based hardware clock for PTP, may provide high accuracy and stability by being responsible for precise time synchronization between network devices.

The PHC supports time synchronization through the PTP at a hardware level, thereby overcoming software-level constraints and enabling stable synchronization in a high-performance network. This allows the same time to be referred to through exchange of time signals at set time intervals for accurate synchronization between network devices.

In particular, accurate time synchronization is important in the field of an automotive network. This is because advanced driver assistance systems (ADAS) and autonomous driving technology require precise timings between various sensors, actuators, and communication systems within a vehicle. To this end, the PHC can be used to support smooth and accurate communication between vehicle systems, thereby securing the safety and efficiency.

The PHC is responsible for generation and management of PTP hardware time stamps, and may attach the time stamps to data packets to guarantee a correct order of communication. Further, the PHC may provide a consistent time reference between several devices within the same network, for smooth cooperation and linkage between various devices.

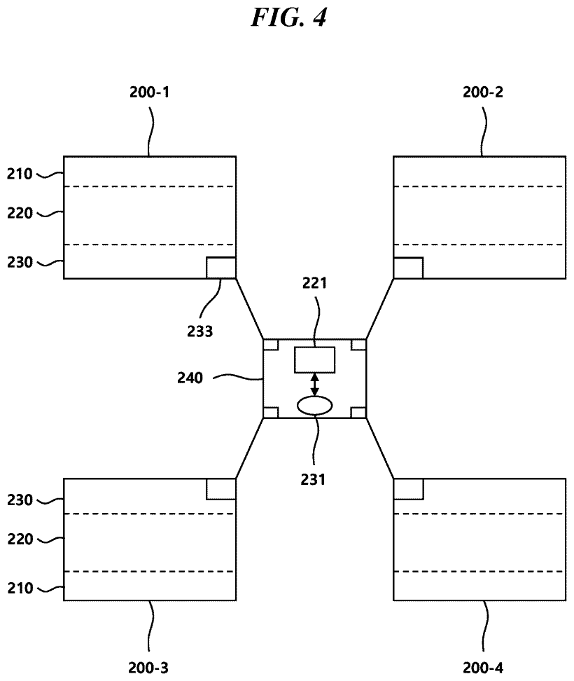

FIG. 4 is a diagram illustrating an example in which a plurality of ECUs in the vehicle network use the same time band through time synchronization according to an embodiment.

Referring to FIG. 4, a plurality of ECUs 200-1, 200-2, 200-3, and 200-4 may be connected to a switch unit 240 through Ethernet ports 233 included in the hardware layer 230. This makes it possible for the plurality of ECUs 200-1, 200-2, 200-3, and 200-4 to synchronize the same time data, and all the ECUs in the vehicle network to use the same time band.

In particular, when a master-slave architecture is used, one device may be designated as a master to provide accurate time, and other devices may be synchronized to this master device.

For example, the specific ECU 200-1 among the plurality of ECUs is set as a global time master (GM), the other ECUs 200-2, 200-3, and 200-4 are set as slave ECUs, and symmetric keys are generated in all secure worlds and multicast from the GM 200-1 to the slave ECUs 200-2, 200-3, and 200-4 in the network, so that all the ECUs in the network can use the same time band.

Here, the secure world is a memory space where a trusted application software program is executed, and actual encryption-related operations may be performed. On the other hand, a normal world refers to a memory space where a general application software program is executed.

In an embodiment, the factor synchronized with the time data may be acquired using a pulse per second (PPS) signal.

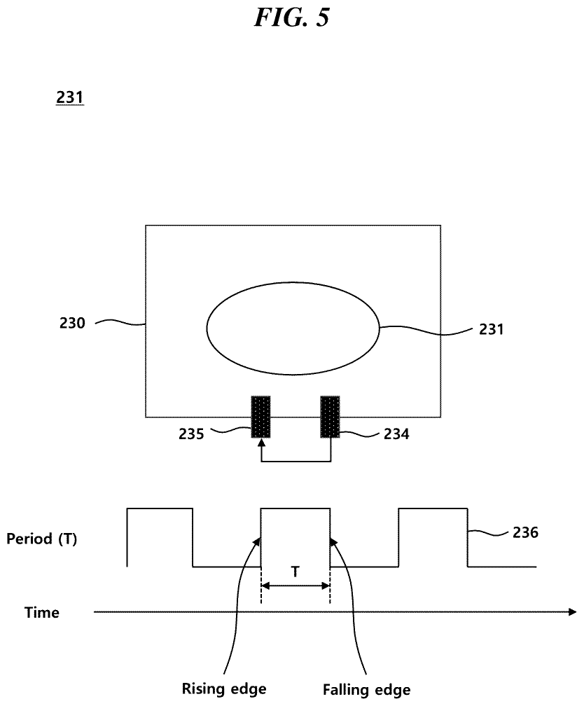

FIG. 5 is a diagram illustrating an example in which the PPS signal is acquired according to an embodiment.

Referring to FIG. 5, the PPS signal may be acquired by connecting a software defined pin (SDP) output 234 of the Ethernet controller included in the hardware layer 230 to an SDP input 235 and then performing a setting so that a pulse 236 is periodically emitted from the SDP output 234.

A signal handler to be used to process a rising edge of the pulse 236 may be registered in the application software program 211, and the time data may be acquired within the registered signal handler.

Specifically, the acquisition of the time data through the PPS signal may be a process in which a start time t at the SDP output 234 and a period T of the pulse 236 are designated so that the pulse 236 is periodically emitted, and the application software program 211 may register a signal handler that processes a rising edge event of the pulse 236 and then call GetTime within the registered signal handler to acquire the time data.

Accordingly, when the application software program 211 receives the PPS signal in each period T of the pulse 236, GetTime may be called through a time synchronization platform 221 to acquire the time data.

The symmetric key 112 may be generated by using the factor synchronized with the time data acquired in this way.

The hardware clock 231 of the transmission unit 201 and the hardware clock 231 of the reception unit 202 may have a time error value of 100 nanoseconds (ns) or less through time synchronization.

Further, since the time data transferred from the hardware clock 231 may have a time error value of 100 ns or less, the time data in microseconds (μs) or more may always have the same value from the time stamp confirmed at each rising edge of the PPS signal. Accordingly, the symmetric key 112 may always have the same value of time data in us or more.

Therefore, the symmetric key 112 may use time data in us or more.

Next, a vehicle network security communication method using symmetric keys derived based on time synchronization according to an embodiment of the present disclosure is described in detail.

A vehicle network security communication method using symmetric keys derived based on time synchronization according to an embodiment of the present disclosure may include: a symmetric key generation step or operation of generating a symmetric key shared by a transmission unit configured to transmit data and a reception unit configured to receive data, and storing the symmetric key in a specific slot. The vehicle network security communication method may also include a symmetric key processing step or operation of calling the symmetric key in the specific slot to transmit and receive data when an application software program creates an encryption or decryption session. The symmetric key may be generated by using a factor synchronized with time data transferred from a hardware clock (HC) included in a hardware layer of electronic control units (ECUs) in a vehicle network.

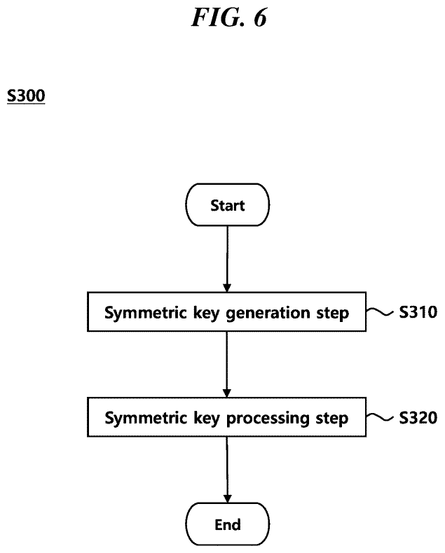

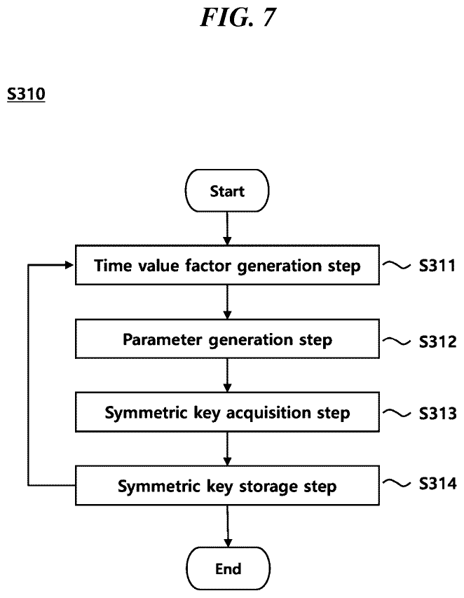

FIG. 6 is a flowchart illustrating a vehicle network security communication method according to an embodiment. FIG. 7 is a flowchart illustrating a symmetric key generation step or operation according to an embodiment.

Referring to FIGS. 6 and 7, a vehicle network security communication method S300 using symmetric keys derived based on time synchronization according to an embodiment includes a symmetric key generation step or operation S310 for generating the symmetric key 112 shared by the transmission unit 201 that transmits data and the reception unit 202 that receives data, and storing the symmetric key 112 in the specific slot 113. The vehicle network security communication method S300 also includes a symmetric key processing step S320 for calling the symmetric key 112 in the specific slot 113 to transmit and receive data when the application software program 211 creates the encryption or decryption session.

Here, the symmetric key 112 may be generated by using the factor synchronized with the time data transferred from the HC 231 included in the hardware layer 230 of the ECUs 200 in the vehicle network.

The symmetric key generation step or operation S310 may include a time value factor generation step or operation S311 for generating the factor synchronized with the time data through the PPS signal received by the application software program 211 included in the application layer 210 of the ECU 200. The symmetric key generation step or operation S310 may also include a parameter generation step or operation S312 for obtaining a parameter by using the generated factor. The symmetric key generation step or operation S310 may further include a symmetric key acquisition step or operation S313 for acquiring the symmetric key 112 through a function operated by the obtained parameter. The symmetric key generation step or operation S310 may additionally include and a symmetric key storage step or operation S314 for storing the acquired symmetric key 112 in the specific slot 113.

The symmetric key 112 may be generated through the key derivation function (KDF).

The symmetric key 112 may be generated by the KDF 111 that operates on the parameters including the input secret key 114, the salt parameter 115, the difficulty level parameter 116, and the key size 117.

Here, the salt 115 parameter may be obtained through the factor synchronized with the time data received from the hardware clock 231.

The PPS signal used in the time value factor generation step or operation S311 performed in the symmetric key generation step or operation S310 may be acquired by connecting the software defined pin (SDP) output 234 of the Ethernet controller included in the hardware layer 230 to the SDP input 235 and then performing a setting so that the pulse 236 is periodically emitted from the SDP output 234.

The signal handler to be used to process the rising edge of the pulse 236 may be registered in the application software program 211, and the time data may be acquired within the registered signal handler.

Specifically, the acquisition of the time data through the PPS signal may be a process in which a start time t at the SDP output 234 and a period T of the pulse 236 are designated so that the pulse 236 is periodically emitted, and the application software program 211 may register a signal handler that processes a rising edge event of the pulse 236 and then call GetTime within the registered signal handler to acquire the time data.

Accordingly, when the application software program 211 receives the PPS signal in each period T of the pulse 236, GetTime may be called through the time synchronization platform 221 so that the time data can be acquired.

The symmetric key 112 may be generated by using the factor synchronized with the time data acquired in this way.

In an embodiment, prior to the symmetric key processing step or operation S320, the symmetric key generation step or operation S310 may be repeatedly performed at each rising edge of the pulse 236 to generate and store the plurality of symmetric keys 112 in advance. This makes it possible to reduce an unnecessary load when the application software program 211 actually operates by using the large number of symmetric keys 112 generated in advance.

The plurality of generated symmetric keys 112 may be stored in a session key dedicated slot 113 of a hardware security module 232. The session key dedicated slot 113 is a volatile slot, and all generated session keys may be deleted when power is turned off. Here, the session key refers to a disposable symmetric key that is used to encrypt all pieces of data in one communication session.

The plurality of generated symmetric keys 112 may be stored in the slot 113, and when the application software program 211 serving to transmit and receive data in the normal world creates an encryption and decryption session, whether to use the symmetric key 112 stored in the specific slot 113 may be determined and then the symmetric key 112 may be called and used. Here, the symmetric key 112 stored in the specific slot 113 may be randomly determined by the transmission unit 201 and then transferred to the reception unit 202, and the determined symmetric key 112 of the slot 113 is called by GetKeyHandle(Slot). Here, the symmetric key 112 stored in the slot 113 may not be used as raw data, and a handle of the symmetric key 112 may be used.

Next, a vehicle network security device using symmetric keys derived based on time synchronization according to an embodiment of the present disclosure is described in detail.

A vehicle network security device using a symmetric key derived based on time synchronization according to an embodiment of the present disclosure may include a symmetric key generation unit configured to generate a symmetric key shared by a transmission unit configured to transmit data and a reception unit configured to receive data, and store the symmetric key in a specific slot. The vehicle network security device may also include a symmetric key processing unit configured to call the symmetric key in the specific slot to transmit and receive data when an application software program creates an encryption or decryption session. The symmetric key may be generated by using a factor synchronized with time data transferred from a hardware clock (HC) included in electronic control units (ECUs) in a vehicle network. A hardware clock of the transmission unit and a hardware clock of the reception unit may have a time error value of 100 ns or less by using the factor synchronized with the time data.

In an embodiment, when the application software program 211 receives the PPS signal in each period T of the pulse 236, GetTime may be called through the time synchronization platform 221 so that the time data can be acquired.

The symmetric key 112 is generated by using the factor synchronized with the time data acquired in this way.

The hardware clock 231 of the transmission unit 201 and the hardware clock 231 of the reception unit 202 may have a time error value of 100 ns or less through time synchronization.

Further, since the time data transferred from the hardware clock 231 can have a time error value of 100 ns or less, the time data in us or more may always have the same value from the time stamp confirmed at each rising edge of the PPS signal. Accordingly, the symmetric key 112 may always have the same value of time data in us or more.

Therefore, the symmetric key 112 may use the time data in us or more.

The terms “include”, “configure”, and “have” as used herein mean that a component can be included unless otherwise specifically stated, and therefore should be construed as further including other components rather than excluding the other components. All terms including technical or scientific terms have the same meaning as generally understood by those having ordinary skill in the art to which the present disclosure pertains, unless otherwise defined. Terms commonly used, such as terms defined in a dictionary, should be construed as being consistent with the meanings in the context of the related art, and should not be construed in an ideal or overly formal sense unless explicitly defined in the present disclosure.

The above description is merely an illustrative description of the technical idea of the present disclosure, and those having ordinary skill in the art to which the present disclosure pertains can make various modifications and variations without departing from the scope of the present disclosure. Therefore, the embodiments described in the present disclosure are not intended to limit the technical idea of the present disclosure but rather are intended to explain the technical idea, and the scope of the technical idea of the present disclosure is not limited by these embodiments. The scope of protection of the present disclosure should be construed by the appended claims, and all technical ideas within the equivalent scope should be construed as being included in the scope of the rights of the present disclosure.

What is claimed is:

1. A vehicle network security system using symmetric keys derived based on time synchronization, the vehicle network security system comprising:
a symmetric key generation unit configured to:
generate a symmetric key shared by a transmission unit configured to transmit data and a reception unit configured to receive data, and
store the symmetric key in a specific slot; and
a symmetric key processing unit configured to call the symmetric key in the specific slot to transmit and receive data when an application software program creates an encryption or decryption session, wherein the symmetric key is generated using a factor synchronized with time data transferred from a hardware clock (HC) included in electronic control units (ECUs) in a vehicle network.

2. The vehicle network security system of claim 1, wherein the symmetric key is generated through a key derivation function (KDF).

3. The vehicle network security system of claim 2, wherein the KDF is operated on parameters including an input secret key, a salt parameter, a difficulty level parameter, and a key size.

4. The vehicle network security system of claim 3, wherein the salt parameter is obtained through the factor synchronized with the time data.

5. The vehicle network security system of claim 1, wherein an ECU, among the ECUs in the vehicle network, includes an application layer including an application software program, a hardware layer including a hardware configuration, and an adaptive platform layer for interaction between the application layer and the hardware layer.

6. The vehicle network security system of claim 5, wherein:
the hardware clock is included in the hardware layer; and
the hardware clock includes a hardware clock for an Ethernet-based precision time protocol (PTP).

7. The vehicle network security system of claim 5, wherein the factor synchronized with the time data is acquired by using a pulse per second (PPS) signal.

8. The vehicle network security system of claim 7, wherein the PPS signal is acquired by connecting a software defined pin (SDP) output of an Ethernet controller included in the hardware layer to an SDP Input of the Ethernet controller and performing a setting so that a pulse is periodically emitted from the SDP output.

9. The vehicle network security system of claim 8, wherein a signal handler used to process a rising edge of the pulse is registered in the application software program, and wherein the time data is acquired within the registered signal handler.

10. The vehicle network security system of claim 1, wherein a hardware clock of the transmission unit and a hardware clock of the reception unit have a time error value of 100 nanoseconds (ns) or less by using the factor synchronized with the time data.

11. The vehicle network security system of claim 1, wherein the symmetric key is generated using time data in a microsecond (μs) or more.

12. A vehicle network security communication method using symmetric keys derived based on time synchronization, the vehicle network security communication method comprising:
generating a symmetric key shared by a transmission unit configured to transmit data and a reception unit configured to receive data;
storing the symmetric key in a specific slot; and
calling the symmetric key in the specific slot to transmit and receive data when an application software program creates an encryption or decryption session,
wherein the symmetric key is generated using a factor synchronized with time data transferred from a hardware clock (HC) included in a hardware layer of electronic control units (ECUs) in a vehicle network.

13. The vehicle network security communication method of claim 12, wherein generating the symmetric key includes:
generating the factor synchronized with the time data through a pulse per second (PPS) signal received by an application software program included in an application layer of an ECE among the ECUs in the vehicle network;
obtaining a parameter by using the factor;
acquiring the symmetric key through a function operated by the parameter; and
storing the acquired symmetric key in the specific slot.

14. The vehicle network security communication method of claim 13, wherein the symmetric key is generated through a key derivation function (KDF).

15. The vehicle network security communication method of claim 14, wherein the KDF is operated on parameters including an input secret key, a salt parameter, a difficulty level parameter, and a key size.

16. The vehicle network security communication method of claim 15, wherein the salt parameter is obtained through the factor synchronized with the time data.

17. The vehicle network security communication method of claim 13, wherein the PPS signal is acquired by connecting a software defined pin (SDP) output of an Ethernet controller included in the hardware layer to an SDP Input of the Ethernet controller and then performing a setting so that a pulse is periodically emitted from the SDP output.

18. The vehicle network security communication method of claim 17, wherein, prior to calling the symmetric key, generating the symmetric key is repeatedly performed at each rising edge of the pulse to generate and store a plurality of symmetric keys in advance.

19. A vehicle network security device using symmetric keys derived based on time synchronization, the vehicle network security device comprising:
a symmetric key generation unit configured to:
generate a symmetric key shared by a transmission unit configured to transmit data and a reception unit configured to receive data, and
store the symmetric key in a specific slot; and
a symmetric key processing unit configured to call the symmetric key in the specific slot to transmit and receive data when an application software program creates an encryption or decryption session,
wherein:
the symmetric key is generated using a factor synchronized with time data transferred from a hardware clock (HC) included in electronic control units (ECUs) in a vehicle network, and
a hardware clock of the transmission unit and a hardware clock of the reception unit have a time error value of 100 nanoseconds (ns) or less by using the factor synchronized with the time data.

20. The vehicle network security device of claim 19, wherein the symmetric key uses time data in a microsecond (μs) or more.
